(19) United States
(12) Patent Application Publication
(10) Pub. No.: US 2003/0231432 A1
(43) Pub. Date: Dec. 18, 2003

(54) Windage, shock and low mass conventional suspension design

(75) Inventors: Sandeepan Bhattacharya, Eagan, MN (US); Andrew John Hutchinson, New Prague, MN (US)

Correspondence Address: MERCHANT & GOULD PC, P.O. BOX 2903, MINNEAPOLIS, MN, 55402-0903, US

(73) Assignee: Seagate Technology LLC, Scotts Valley, CA

(21) Appl. No.: 10/428,555

(22) Filed: May 2, 2003

Related U.S. Application Data
(60) Provisional application No. 60/389,816, filed on Jun. 18, 2002.

(51) Int. Cl. G11B 5/48

(52) U.S. Cl. 360/244.2

(57) ABSTRACT

A data storage device includes a head and a suspension assembly capable of supporting the head. The suspension assembly includes a base plate having a first base plate surface facing toward the storage medium, and a load beam having a length, a first load beam surface facing toward the storage medium, and a second load beam surface facing toward the first base plate surface. The second load beam surface is secured to the first base plate surface, and an interconnect of the storage device is secured to the first load beam surface along substantially the entire load beam length.

### CROSS REFERENCE TO RELATED APPLICATIONS

This application claims priority from U.S. Provisional Application Serial No. 60/389,816, filed Jun. 18, 2002 and entitled IMPROVED WINDAGE, SHOCK AND LOW MASS CONVENTIONAL SUSPENSION DESIGN.

### BACKGROUND OF THE INVENTION

1. Field of the Invention

The present invention relates to data storage devices. In particular, the present invention relates to improving performance of suspension assemblies in data storage devices.

2. Related Art

In data storage devices, data is typically stored in tracks on a memory medium. To access the data, the head is positioned within a track of the memory medium while the medium moves beneath the head.

In many storage devices, the head is positioned by an actuator assembly that includes a motor that rotates one or more actuator arms. Each actuator arm supports one or two suspensions that each support a head/gimbal assembly. Typically, a suspension includes three distinct areas: a base plate area that connects to the actuator arm, a spring area that provides a vertical spring force to bias the head toward the medium, and a load beam that extends from the spring area to the head/gimbal assembly. A spring force provided by the suspension is designed to allow the head to follow height variations on the surface of the medium without impacting the medium or moving too far away from the medium. Typically, it is desired that the spring area be more elastic or flexible than the remainder of the suspension. However, if the spring area or the remainder of the load beam is too elastic and compliant the load beam will tend to bend and resonate in response to windage induced forces.

Windage induced forces have become a particular concern as the performance of disc drives has increased. For example, many high performance drives run at 15 k RPM or higher, causing significant windage forces within the disc drive. Also, there is an increasingly higher number of bits being packed into every square inch of the disc drive surface, leading to a higher number of tracks per inch and a reduced track width. As a result, suspensions are more susceptible to slider off-track motion and other mechanical resonant vibrations that lead to reduced servo bandwidth and reduced track following capabilities of the disc drive.

In order to minimize slider off-track motion due to windage, the suspension design may be altered in such a way so as to achieve higher resonance frequencies without compromising on the performance requirements of the disc drive. An effective way to reduce slider off-track motion resulting from windage excitation is to increase the suspension resonant frequencies. Suspension resonance frequencies can be increased by, for example, reducing the length of the suspension, using a thicker sheet of material for the load beam and bend section, or reducing the effective bend length of the suspension. These options have inherent drawbacks and costs that may be significant enough to make them an undesirable option. For example, thicker suspension material is heavier and also deteriorates drive level shock and seek access time performance. Shorter and thicker suspensions usually have very high vertical stiffness that results in additional re-working of the head stack assembly process to achieve the desired gram load to the head/gimbal assembly.

Windage driven slider off-track motion may also result from the excitation of the electrical interconnect tail adjacent to the base plate area of the suspension. To minimize this excitation, the tail is usually attached to suspension tabs that extend from the base plate or load beam. However, attaching the interconnect tail to suspension tabs does not completely eliminate the problem as the suspension tabs are typically compliant and asymmetrical, and can translate the windage driven tail motion into slider off-track motion. As mentioned above, the problem of windage induced motion has become a more significant problem as the windage forces increase with increased rotation speeds of the storage medium.

### SUMMARY OF THE INVENTION

A data storage device includes a head and a suspension assembly capable of supporting the head. The suspension assembly includes a base plate having a first base plate surface facing toward the storage medium, and a load beam having a length, a first load beam surface facing toward the storage medium, and a second load beam surface facing toward the first base plate surface. The second load beam surface is secured to the first base plate surface, and an interconnect of the storage device is secured to the first load beam surface along substantially the entire load beam length.

In another aspect of the invention, a data storage device for storing and accessing data in tracks on a storage medium includes a head configured to read information from the storage medium and a suspension assembly arranged and configured to support the head. The suspension assembly includes a base plate having a width and a length, a first surface facing the storage medium, and a second surface facing away from the storage medium. The suspension assembly also includes a load beam having a proximal end and a distal end, a first surface facing the storage medium, and a second surface facing away from the storage medium with the proximal end of the load beam being secured to the base plate. The storage device also includes an interconnect extending between the distal end of the load beam and the base plate and physically oriented along the first surface of the load beam and the first surface of the base plate such that the orientation of the interconnect minimizes unstabilizing forces to the suspension assembly.

In a yet further aspect of the invention, a head suspension assembly for a disc drive having a storage medium includes a load beam and a base plate. The load beam includes a distal end and a proximal end, a first surface facing away from the storage medium, and a second surface facing toward the storage medium. The base plate includes a length and a width, a first surface facing away from the storage medium, and a second surface facing toward the storage medium. The second surface of the base plate is secured to the first surface of the load beam and the width of the base plate is wide enough to secure an interconnect of the disc drive to the first surface of the base plate.

These and various other features as well have advantages that characterize the present invention and will be apparent upon reading of the following detailed description and review of the associated drawings.

### BRIEF DESCRIPTION OF THE DRAWINGS

FIG. 1 is a top perspective view of a disc drive in which several discs have been removed to show various features of the disc drive in which embodiments of the present invention may be practiced.

FIG. 2A is a top perspective view of a suspension assembly under the prior art.

FIG. 2B is a top plan view of a suspension assembly under the prior art.

FIG. 2C is a bottom plan view of a suspension assembly under the prior art.

FIG. 3A is a top perspective view of one embodiment of a suspension assembly according to principles of the invention.

FIG. 3B is a top plan view of the embodiment shown in FIG. 3(a).

FIG. 3C is a bottom plan view of the embodiment shown in FIG. 3(a).

FIG. 3D is a side view of the embodiment that is shown in FIG. 3(a).

### DETAILED DESCRIPTION OF THE PREFERRED EMBODIMENT

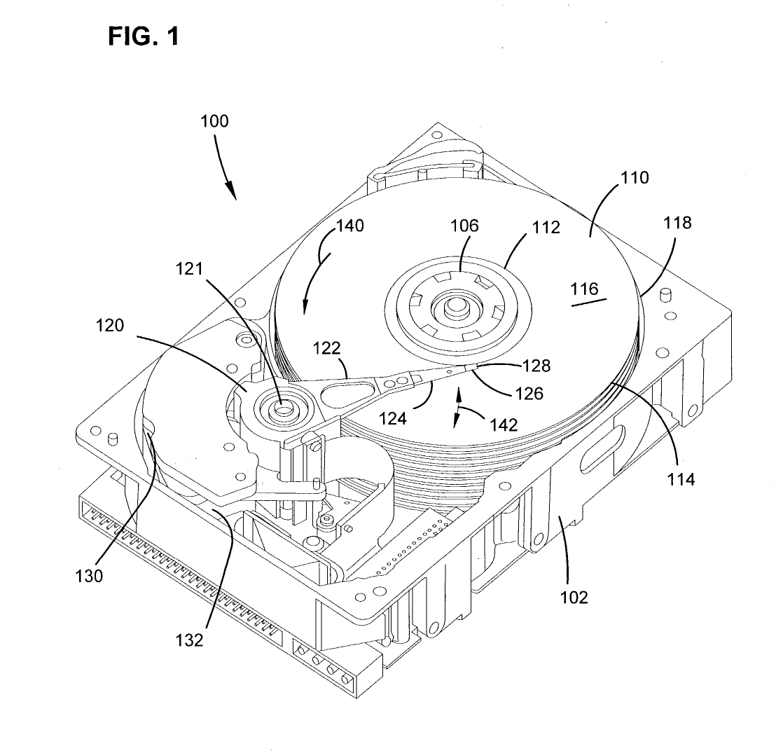

FIG. 1 is an asymmetric view of a disc drive 100 having structure in which principles of the present invention may be practiced. The disc drive 100 includes a base 102, and a cover (not shown). Base 102 and the cover form a disc drive enclosure. Extending into base 102 is a spindle motor 106 to which several discs 110 are secured. Each disc 110 is generally angular in shape, with an inner edge 112 and an outer edge 114 circumscribing opposing disc surfaces 116 (of which only one is visible in the drawing) to which data can be stored for later retrieval. Base 102 provides a cavity or room for disc 110 to be seated in a substantially coaxial arrangement, with an inner wall 118 of the base running around outer edges 114 of disc 110, substantially transverse to disc surfaces 116.

On one side of a pivot 121, an actuator assembly 120 includes a plurality of arms 122 to which are attached load beams or suspensions 124. At the end of each suspension 124 is a slider 126 that carries the read/write devices (designated generally by 128). The present invention is equally applicable to sliders having different types of read/write devices, such as what is generally referred to as transducers, magneto resistive heads, giant magneto resistive heads, or tunneling magneto resistive heads. On another side of the pivot, actuator assembly 120 extends to support a voice coil 130 next to one or more magnets 132 fixed relative to base 102. When energized, resultant electromagnetic forces on voice coil 130 cause actuator assembly 120 to rotate about pivot 121, thereby bringing the read/write devices into various radio locations relative to disc surfaces 116. It can be seen that, with spindle motor 106 rotating discs 110 for example, in a direction indicated by arrow 140, and actuator assembly 120 moving read/write heads 128 in an arcuate path, as indicated by arrow 142, across disc surfaces 116, various locations on disc surfaces 116 can be accessed by the read/write heads for data recordation or retrieval.

As discs 110 are rotated, fluid or air adjacent to disc surfaces 110 is also brought into motion, generating air streams or flow currents in the disc drive enclosure. This airflow, or windage, create forces both in direction 140 in the plane of disc surfaces 116, as well as a direction normal to the plane of disc 116. There also may be various other windage-induced forces occurring throughout the cavity provided by base 102 and cover 104.

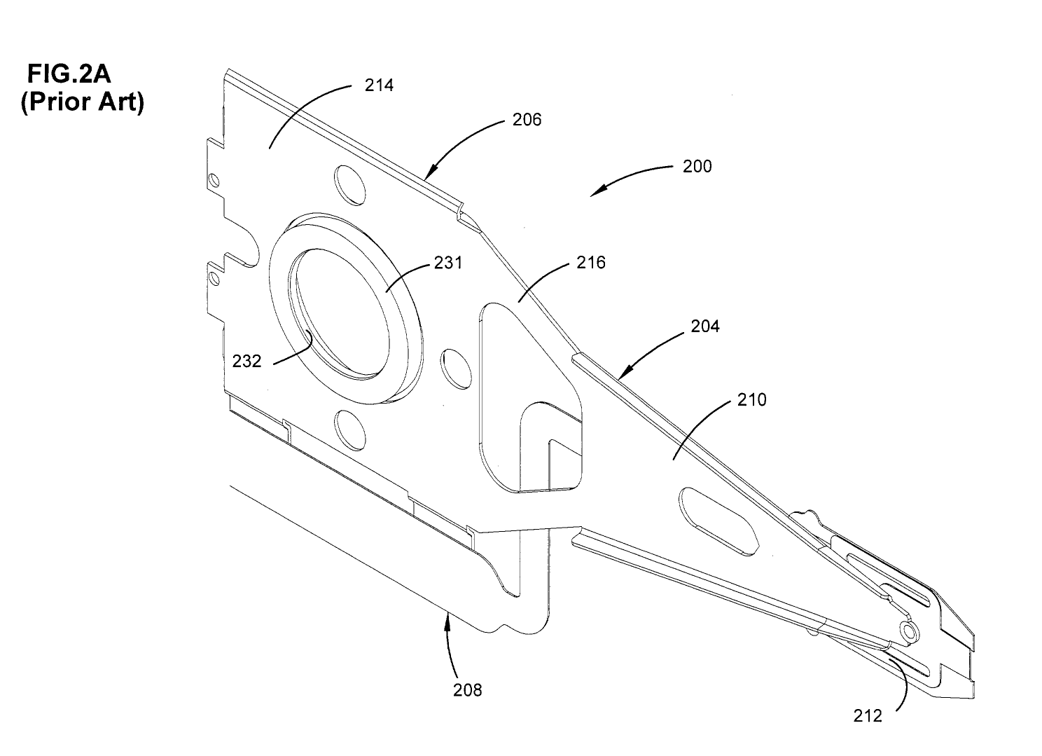

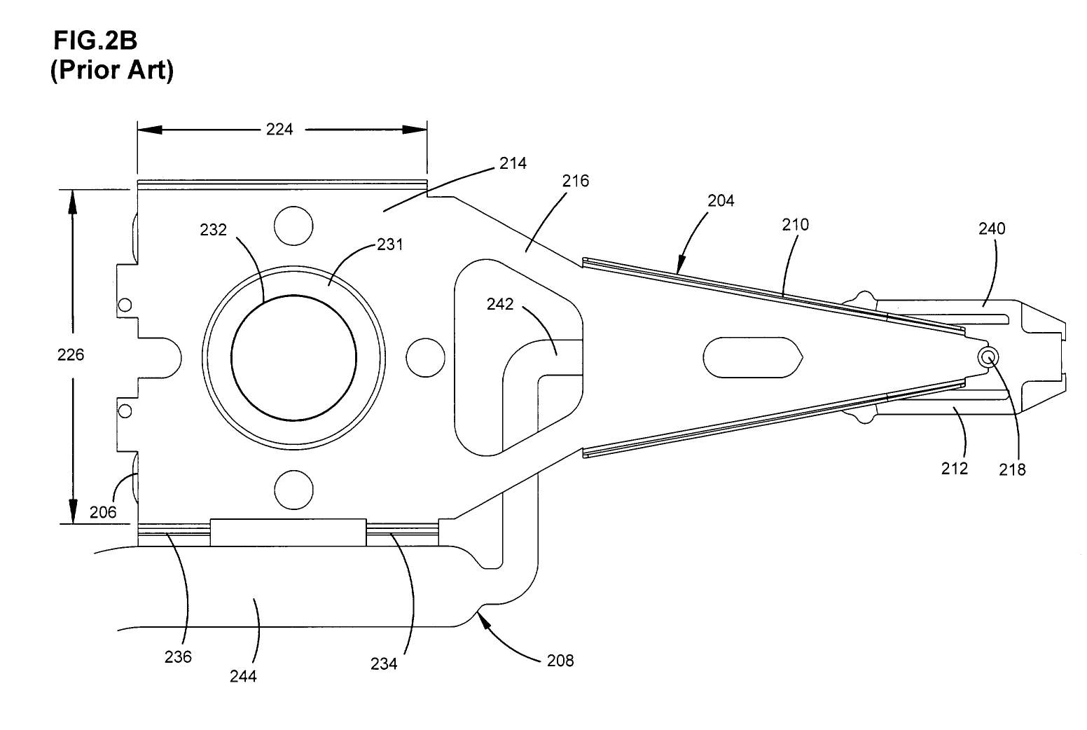

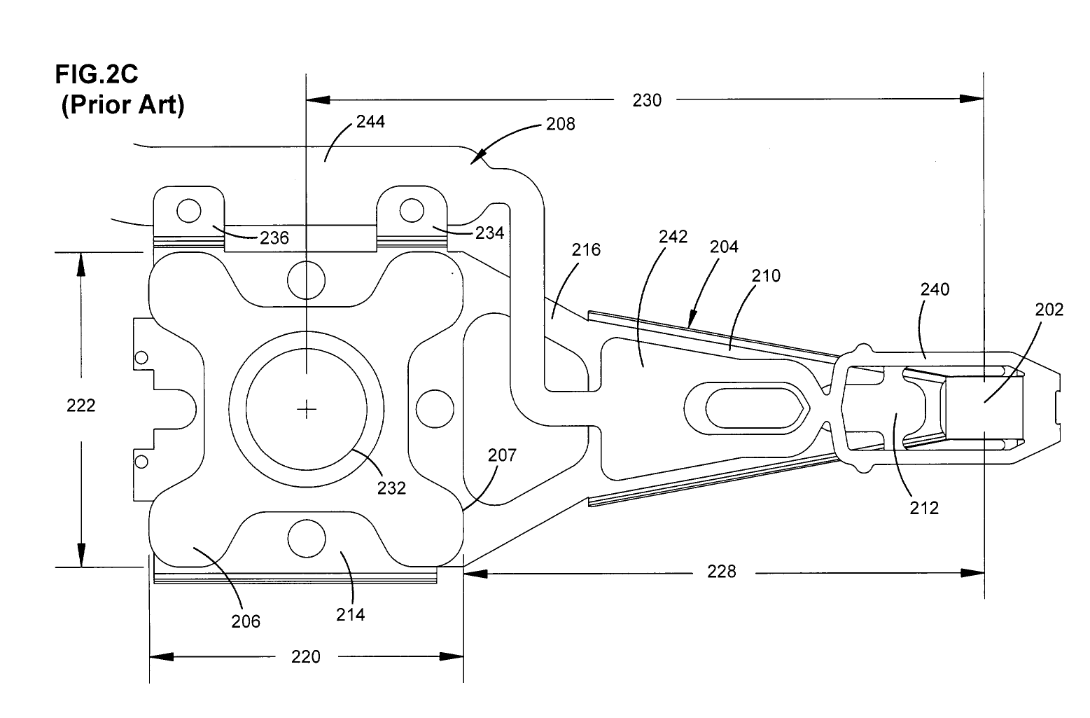

FIGS. 2A-C are perspective, front, and back views, respectively, of a suspension assembly 200 of the prior art. Assembly 200 includes a head 202, a load beam 204, and a base plate 206 mounted with a boss (not shown). Load beam 204 includes a rigid portion 210, a gimbal portion 212, a base portion 214 and a bend portion 216. Gimbal portion 212 supports head 202 via a connection at dimple point 218 of gimbal portion 212. Base portion 214 of load beam 204 is sandwiched between base plate 206 and a support arm of the disc drive assembly.

Base plate 206 has a length and a width 220, 222, respectively, that is comparable to a length and width 224, 226 of base portion 214 of load beam 204. Length 220 of base plate 206 in the direction of head 202 determines in part a suspension bend length 228 that is measured between an end 207 (see FIG. 2C) of base plate 206 and dimple point 218 of gimbal portion 212. Assembly 200 also includes a suspension length 230 that extends from a center axis of a boss hole 232 of base plate 206 to dimple point 218.

Width 222 of base plate 206 and width 226 of base portion 214 of load beam 204 are configured to provide sufficient structure adjacent boss aperture 232 to support of load beam 204 and head 202, while being no wider than is necessary so as to keep the weight and mass of the suspension assembly at a minimum. Widths 222, 226 are typically sized to match a width of the disc drive assembly support arm at the boss connecting point. Known suspension assemblies have not disclosed a way to increase widths 222, 226 beyond the width of the disc drive assembly support arm without significantly increasing the weight of the suspension assembly and compromising suspension assembly performance.

Assembly 200 also includes an interconnect 208 having a gimbal portion 240, a load beam portion 242, and a base portion 244. Gimbal portion 240 is electrically connected with read/write transducers that are mounted on head 202. Gimbal portion 240 is typically compliant and free floating in order to permit the necessary flexibility of head 202 relative to load beam 204. Typically, load beam portion 242 extends along a longitudinal axis of load beam 204. Base portion 244 typically extends along a side of base plate 206 and base portion 214 of load beam 204 and is connected to front and rear load beam tabs 234, 236 that extend from load beam 204.

As discussed above, load beam tabs 234, 236 are typically simple extensions of load beam 204 and are thus made from the same relatively compliant material having the same thickness as load beam 204. As a result of this configuration, load beam tabs 234, 236 are subject to bending and torsion forces that may occur from windage within the disc drive assembly, especially when flex circuit 208 is mounted to load beam tabs 234, 236. Thus, as the windage forces increase, particularly as RPMs of the storage medium increase, interconnects secured to assembly 200 via load beam tabs 234, 236, subject the assembly 200 to significant forces that typically increase off track motion of head 202.

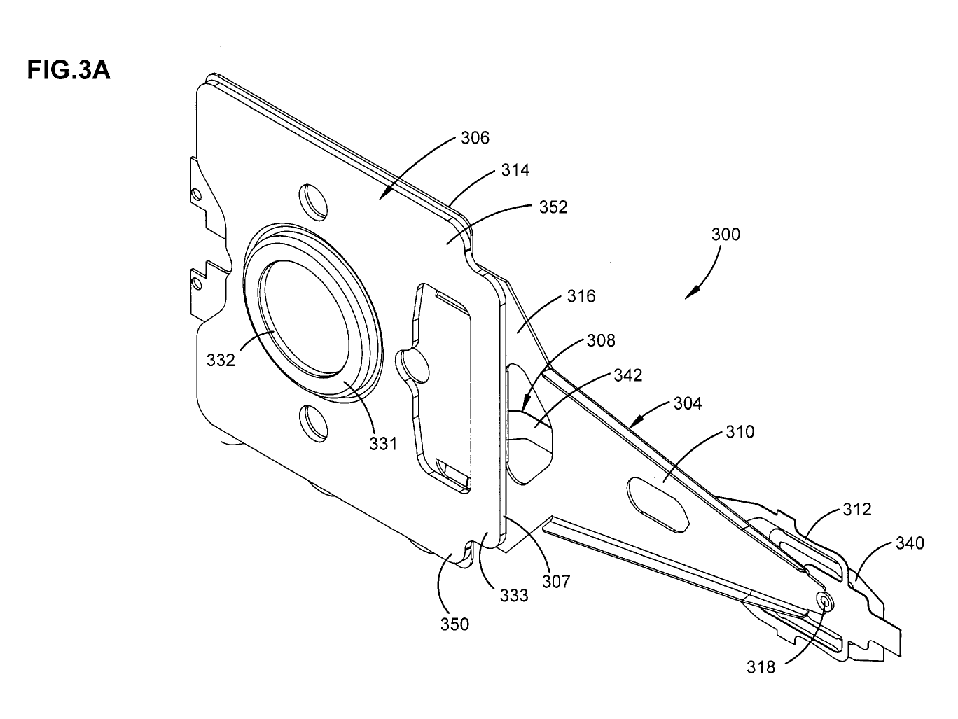

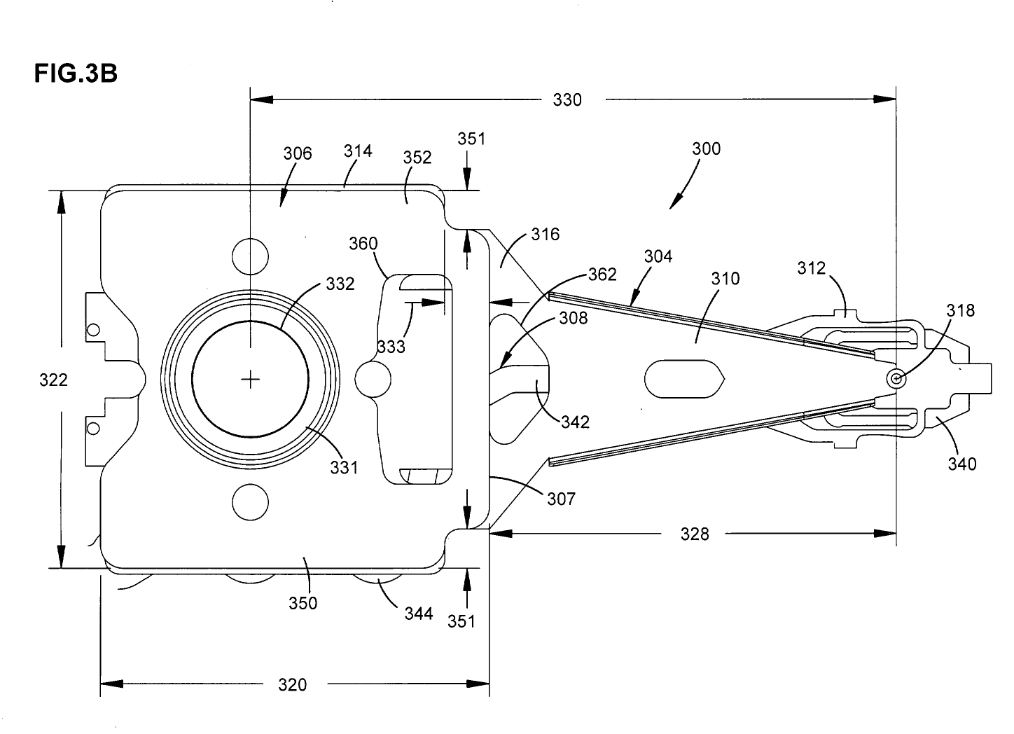

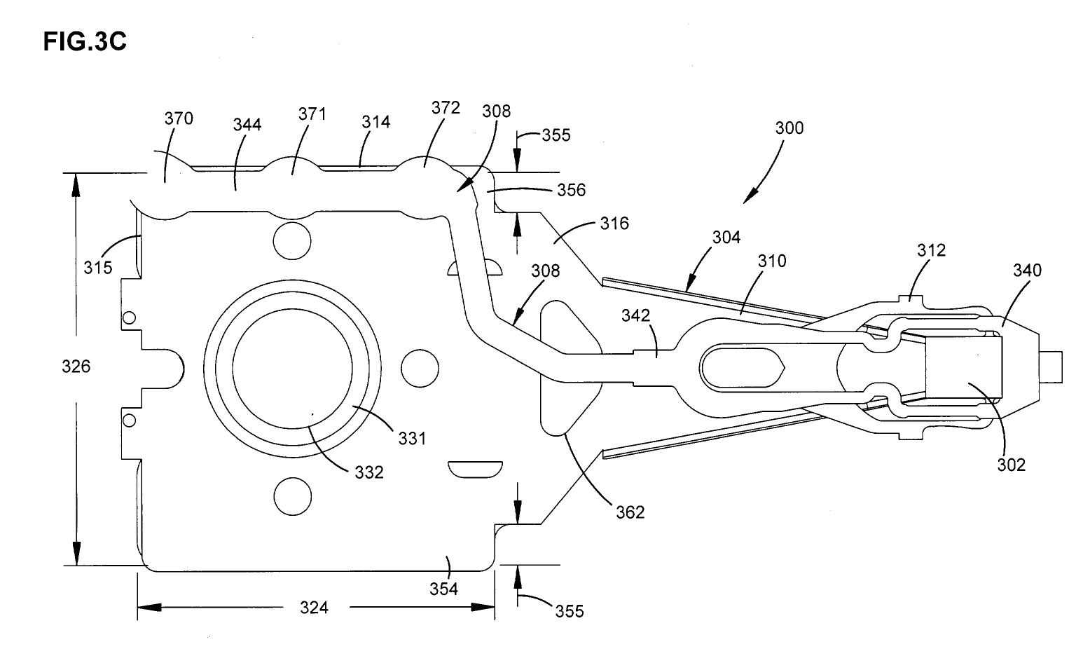

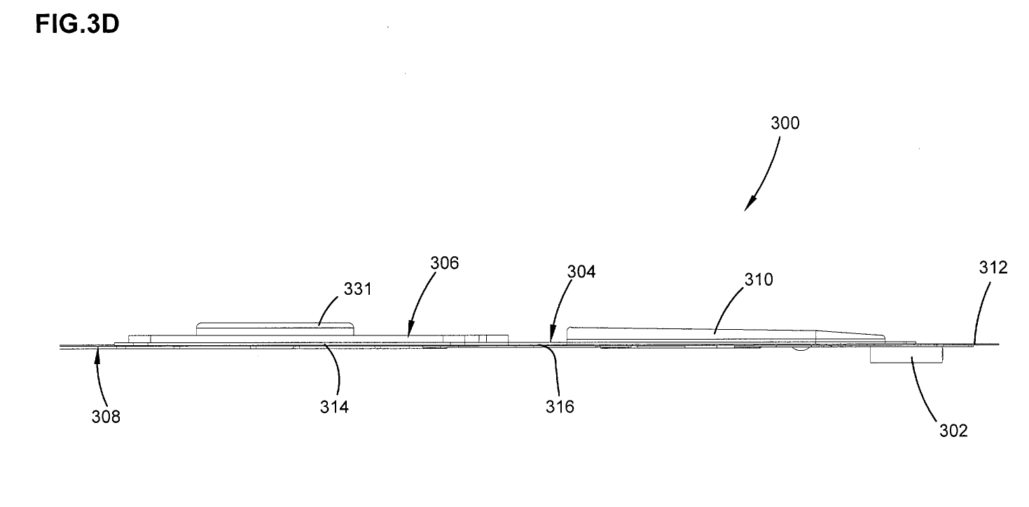

FIGS. 3A-D provide perspective, top, bottom and side views, respectively, of a example suspension assembly 300 of the invention. Assembly 300 includes a head 302, a load beam 304, a base plate 306 and an interconnect 308. Load beam 304 includes a rigid portion 310, a gimbal portion 312 supporting head 302, a base portion secured to base plate 306, and a flexible portion or bend section 316. Although load beam 304 is shown in FIGS. 3A-D as a planer member without a bend formed therein, load beam 304 is typically bent at bend section 316 so as to provide a preload bend force that is applied between head 302 and the memory medium of the disc drive assembly.

Base plate 306 has a length 320 and a width 322, and base portion 314 has a length 324 and a width 326 that are comparable to length and width 320, 322. Width 322 includes a width 351 of first and second base plate shelves 350, 352. Width 326 of base portion 314 also includes a width 355 of first and second load beam shelves 354, 356. Widths 351, 355 represent the distance the base plate 306 and base portion 314 extend beyond the width of a support arm of the disc drive assembly, which typically corresponds to the width of base plate 226 and load beam base portion 214 shown in the prior art of FIGS. 2A-C. The additional width of the shelves 350, 352, 354, 356 beyond the width of the support arm provide a mounting surface to which the interconnect 308 may extend along and be secured to without interfering with required clearances around boss aperture 332 or interfere with the connection of suspension assembly 300 to the support arm.

Interconnect 308 includes a gimbal portion 340, a load beam portion 342 and a base portion 344. Gimbal portion 340 is electrically connected with head 302. Gimbal portion 340 is typically compliant to permit free pivotal movement of head 302 about dimple point 318. Load beam portion 342 extends along a longitudinal axis of rigid portion 310 of load beam 304. Preferably, load beam portion 342 is secured at various points along the length of rigid portion 310 while remaining compliant through at least a portion of the flexible portion 316 of load beam 304 to allow unrestricted bending of flexible portion 316. At a point near flexible portion 316, load beam portion 342 transitions to a side of base portion 314 so as to extend along load beam shelf 356 and base plate shelf 352. Because assembly 300 includes a reverse load beam orientation, that is, load beam 306 being mounted on the memory medium side of base plate 306 so as to sandwich base plate 306 between load beam portion 314 and the support arm of the disc drive assembly, interconnect 308 is able to extend smoothly and without an interruption in surface structure along load beam 304 from gimbal portion 312 to base portion 314.

Although interconnect 308 may not be continuously connected to load beam 304 along an entire length of load beam 304 from gimbal portion 312 to a proximal end 315 (see FIG. 3C) due to aperture 362 and other functional considerations, interconnect 308 may be considered to be secured to load beam 304 along substantially the entire load beam length.

In alternative embodiments that do not include a reverse load beam orientation, interconnect 308 may extend along load beam 304 from gimbal portion 312 through flexible portion 316, and then transition to a surface of base plate 306 that is facing the memory medium of disc drive assembly. In yet further embodiments, load beam 304 does not include first and second load beam shelves 354, 356, thus requiring the base portion 344 of interconnect 308 to be secured directly to the first or second base plate shelf 350, 352 as interconnect 308 extends along length 324, 320 of load beam 304 and base plate 306, respectively. In yet further embodiments, base portion 344 of interconnect 308 may extend along the first base plate shelf 350 and the first load beam shelf 354.

Base plate 306 may also include an extension 333 that extends in the direction of head 302. Extension 333 may provide additional support to load beam 304 at the transition point between base portion 314 and flexible portion 316. Extension 333 may provide a reduction in the suspension bend length 328 as compared to the suspension bend length 228 shown in FIG. 2C of the prior art. As discussed earlier, a shorter suspension bend length increases the resonant frequencies of a suspension. The additional stiffness inherent with a shorter suspension bend length may be compensated for by making the flexible portion of the suspension load beam more compliant by either removing additional material by increasing the size of an aperture formed in the flexible portion (such as aperture 362 formed in flexible portion 314), or by reducing the thickness of the load beam either in the flexible portion 316 alone, or throughout load beam 304.

Preferably, the thickness of the sheet material used for load beam 304 is reduced as compared to the thickness of material used for load beam 204 in known load beams. A thinner material for load beam 304 (given the same type of material) reduces the overall weight of the load beam, which may both provide additional compliance in flexible portion 314 and compensate for the added weight from load beam shelves 354, 356. Known load beams typically require a sheet material having a thickness of between 0.002-0.004 inches. Load beam 304 preferably requires a sheet material having a thickness less than 0.002 inches and most preferably a thickness of 0.0015 inches of stainless steel material. As a result, the net mass of the load beam 304 is about equal to or less than the mass of load beam 204 of the prior art.

Base plate 306 also preferably uses a sheet material having a thickness less than the thickness of material used for base plate 206 of the prior art in order to compensate for the additional width of base plate shelves 350, 352 and length extension 307. The thickness of known base plate material is greater than 0.0059 inches, while the thickness of base plate 306 is less than about 0.005 inches, and most preferably about 0.0049 inches thick stainless steel. An additional way to reduce the mass or weight of base plate 306 is to remove some of the base plate material with an aperture 360 in an area of base plate 306 that has less supporting functionality.

Base plate 206 of the prior art shown in FIGS. 2A-C is approximately square-shaped having a length and width dimension of 0.2×0.2 inches with boss aperture 232 positioned approximately in the center of the square. Base plate 306 includes an additional 0.03 inches in added width for each of the base plate shelves 350, 352 for a total of 0.06 inches additional width over width 222 of base plate 206. Base plate 306 also includes an additional 0.06 inches in length over length 220 of base plate 206 due to extension 332. In order to maintain the same form factor when assembling suspension 300 as compared to the form factor standard in the art, boss aperture 332 is positioned off center (in a direction away from head 302) on the approximately square-shaped base plate 306. Because of the additional length of extension 333, suspension bend length 328 can be shortened relative to suspension bend length 228 shown in FIG. 2C.

When assembling base plate 306, load beam 304 and interconnect 308 together, base plate 306 is first secured, typically with an adhesive or welding, to base portion 314 of bend section 304. Interconnect 308 may be secured to load beam 304 and base plate 306 in a variety of different ways including, but not limited to, adhesives, welding, and thermal bonding. Base portion 344 of interconnect 308 may be laser welded to base portion 314 and base plate 306 at locations 370, 371, 372 and multiple other locations along the length of the interconnect. Laser welding is a known method of precisely securing multiple layers together.

One advantage of the reverse load beam orientation shown in FIGS. 3A-D is that the load beam is closer to the memory medium of the disc drive assembly. As a result of the closeness of the load beam to the memory medium, less of a bend is required in the flexible portion of the load beam in order to provide the required pre-load forces between head 302 and the memory medium, as compared to a traditional load beam orientations. Less of a bend in the flexible portion may result in reduced amounts of buckling of the load beam and an increase in lateral stiffening of the load beam as compared to load beams with a greater bend in the flexible portion.

Interconnect 308 of assembly 300 is preferably arranged in such a way relative to base plate 306 and bend section 304 so as to be hidden from a top plan view (see FIG. 3B). As the surface area of interconnect 308 that is unsupported by a section of base plate is reduced to a minimum, assembly 300 becomes less susceptible to windage forces in the plane direction of the memory medium and from windage forces in a normal direction to the memory medium. A suspension assembly that is less susceptible to windage forces may result in improved disc drive performance.

Although the above description has focused on an interconnect that is formed from a flex circuit, interconnect 308 may be replaced by any number of designs or configurations that extend from the head 302 to a location proximal to base plate 306. For example, interconnect 308 may be a twisted pair of wires, or as mentioned above, electrical leads embossed directly on the surface of load beam 304 and base plate 306.

The present invention may provide numerous advantages as compared to known suspension assemblies, in particular the prior art shown in FIGS. 2A-C. For example, suspension 300 provides the lowest measured windage induced slider off-track motion among known conventional suspension designs. Suspension 300 also provides the highest measured first bending frequency, the highest measured first torsion frequency, and the highest measured sway frequency among all known conventional, single state suspension designs. The load beam of suspension 300 makes use of the thinnest load beam sheet material and the thinnest base plate sheet material among all known conventional suspension designs, thus reducing the assembly mass. Suspension 300 also provides the highest head slap threshold among known conventional conventional, single stages suspension designs. Consequently, the present invention provides improvements and advantages over the prior art.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A data storage device for storing and accessing data in tracks on a storage medium, the storage device comprising:
a head;
a suspension assembly capable of supporting the head, including:
a base plate having a first base plate surface facing toward the storage medium;
a load beam having a length, a first load beam surface facing toward the storage medium and a second load beam surface facing toward the first base plate surface, the second load beam surface being secured to the first base plate surface; and
an interconnect secured to the first load beam surface along substantially the entire load beam length.

2. The storage device of claim 1, wherein the load beam further comprises a base portion having a width and the base plate further comprises a width, and the base plate width and the base portion width are substantially equal.

3. The storage device of claim 2, further comprising a support arm configured to mount the suspension assembly to the storage device, the support arm having a width at a location on the support arm to which the suspension assembly is mounted that is less than the base portion width, wherein the interconnect is secured to that portion of the base portion that is wider than the support arm.

4. The storage device of claim 1, wherein the load beam length extends from a proximal end of the load beam to a distal end of the load beam that supports the head.

5. A data storage device for storing and accessing data in tracks on a storage medium, the storage device comprising:
a head configured to read information from the storage medium;
a suspension assembly arranged and configured to support the head, including:
a base plate having a width and length, a first surface facing the storage medium, and a second surface facing away from the storage medium;
a load beam having a proximal end and a distal end, a first surface facing the storage medium and a second surface facing away from the storage medium, the proximal end of the load beam being secured to the base plate; and
an interconnect extending between the distal end of the load beam and the base plate and physically oriented along the first surface of the load beam and the first surface of the base plate;
whereby the orientation of the interconnect minimizes unstabilizing forces on the suspension system.

6. The device of claim 5, wherein the interconnect is secured to the load beam.

7. The device of claim 5, wherein the interconnect is secured to the base plate.

8. The device of claim 5, wherein the load beam width and the base plate width are substantially equal.

9. The device of claim 5, wherein the second surface of the load beam is secured to the first surface of the base plate.

10. The device of claim 5, further comprising a support arm configured for mounting the suspension assembly, the support arm having a width that is less than the width of the base plate, whereby the interconnect is secured to that portion of the base plate that extends beyond the width of the support arm.

11. The device of claim 5, wherein the interconnect is a flex circuit.

12. The device of claim 5, wherein portions of the interconnect, when the interconnect is secured to the suspension assembly, are covered with an insulation layer.

13. A head suspension assembly for a disc drive having a storage medium, comprising:
a load beam having a distal end and a proximal end, a first surface facing away from the storage medium, and a second surface facing toward the storage medium;
a base plate having a length and a width, a first surface facing away from the storage medium, and a second surface facing toward the storage medium, the base plate being secured to the load beam and the width of the base plate being wide enough to secure a interconnect of the disc drive to the first surface of the base plate.

14. The assembly of claim 13, wherein the base plate and load beam are configured for mounting to a support arm of the disc drive, and the width of the base plate is wider than a width of the support arm so as to provide a platform to which the interconnect is secured.

15. The assembly of claim 13, wherein the first surface of the load beam is secured to the second surface of the base plate.

16. The assembly of claim 13, wherein the second surface of the load beam is secured to the first surface of the base plate.

17. The assembly of claim 13, wherein the load beam includes a base portion having a width, the base portion width being substantially equal to the base plate width.

18. The assembly of claim 13, wherein the interconnect is secured to the load beam.

19. The storage device of claim 3, wherein the interconnect is completely shielded from windage forces applied to the suspension assembly by that portion of the base portion that is wider than the support arm.

20. The storage device of claim 3, wherein a portion of the base plate extended beyond the support arm in a direction toward the head, and the interconnect is shielded from windage forces by the that portion of the base portion that extends beyond the support arm in a direction toward the head..
